(19) United States
(12) Patent Application Publication
(10) Pub. No.: US 2002/0145756 A1
(43) Pub. Date: Oct. 10, 2002

(54) Passport photograph generation system

(76) Inventor: Steven D. Stoecker, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/828,399

(22) Filed: Apr. 6, 2001

(51) Int. Cl. G06K 1/00

(52) U.S. Cl. 358/1.18; 358/1.6

(57) ABSTRACT

A system for selecting a particular size image to print comprises a computer adapted to receive an electronic image file and a photograph generation software component in communication with the computer. The photograph generation software component is adapted to analyze the electronic image file and present to a user a plurality of image formats from which the user selects a desired format. The invention also includes a method for selecting a particular size image to print. The method includes the steps of providing an electronic image file to a computer, selecting the electronic image file, and presenting to a user a plurality of image formats from which the user selects a desired format with which to print the selected electronic image file.

### BACKGROUND OF THE INVENTION

1. Field of the Invention

The present invention relates generally to electronic imaging devices, and, more particularly, to a photograph generation system that operates in conjunction with a computer processing system to automatically print a selected image in a predetermined or user specified format.

2. Related Art

Personal computers, scanners, printers and other electronic devices are becoming readily available to the average consumer. Such electronic devices are useful for developing documents, sending and retrieving electronic mail (when connected to the Internet), and printing documents. Typically, when an image is to be printed, the image is either developed by or delivered electronically to a computer and then formatted by printer software located on the computer prior to printing. The image is then delivered electronically from the computer to a printer, which renders the image on paper.

With the introduction and widespread availability of digital cameras and other image capturing devices, more and more photographic quality images are being made available in electronic form. These photographic images can be printed by “photographic quality” printers that are becoming widely available. Typically, a file containing an electronic representation of the image is supplied to a computer from, for example, a digital still camera or a digital video camera. Alternatively, a scanner can be used to convert a photograph, or other image, into an electronic format, which is then supplied to a computer. The computer processes the electronic representation of the image and then delivers the electronic representation of the image to the printer. The printer receives the electronic representation of the image and renders a photograph-like print of the image. When printing such images, the size of the final image is determined by the format of the original electronic representation of the image and by the printer used to print the image.

When printing photograph-like images, there are times when it would be desirable to have the ability to print a particular (or predefined) size image. Furthermore, oftentimes it would be desirable for the user of the processing system to have the ability to determine the format and size of the printed image.

Therefore, there is a need in the industry to address the above-mentioned deficiencies and inadequacies.

### SUMMARY

The invention is a system for selecting a particular size image to print comprising a computer adapted to receive an electronic image file and a photograph generation software component in communication with the computer. The photograph generation software component is adapted to analyze the electronic image file and present to a user a plurality of image formats from which the user selects a desired format.

The invention can also be conceptualized as a method for selecting a particular size image to print. The method includes the steps of providing an electronic image file to a computer, selecting the electronic image file, and presenting to a user a plurality of image formats from which the user selects a desired format with which to print the selected electronic image file.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar computer system in which the photograph generation system of the present invention resides.

FIG. 2 is a schematic view illustrating the user interface and photograph generation system of FIG. 1.

FIG. 3 is a flow diagram illustrating the operation of the photograph generation system of FIG. 1.

FIG. 4A is a graphical illustration showing the operation of the photograph generation system of FIG. 1.

FIG. 4B is a schematic view illustrating a user interface of the photograph generation system of FIG. 1.

FIG. 4C is a schematic view illustrating an alternative user interface of the photograph generation system of FIG. 1.

### DETAILED DESCRIPTION OF THE INVENTION

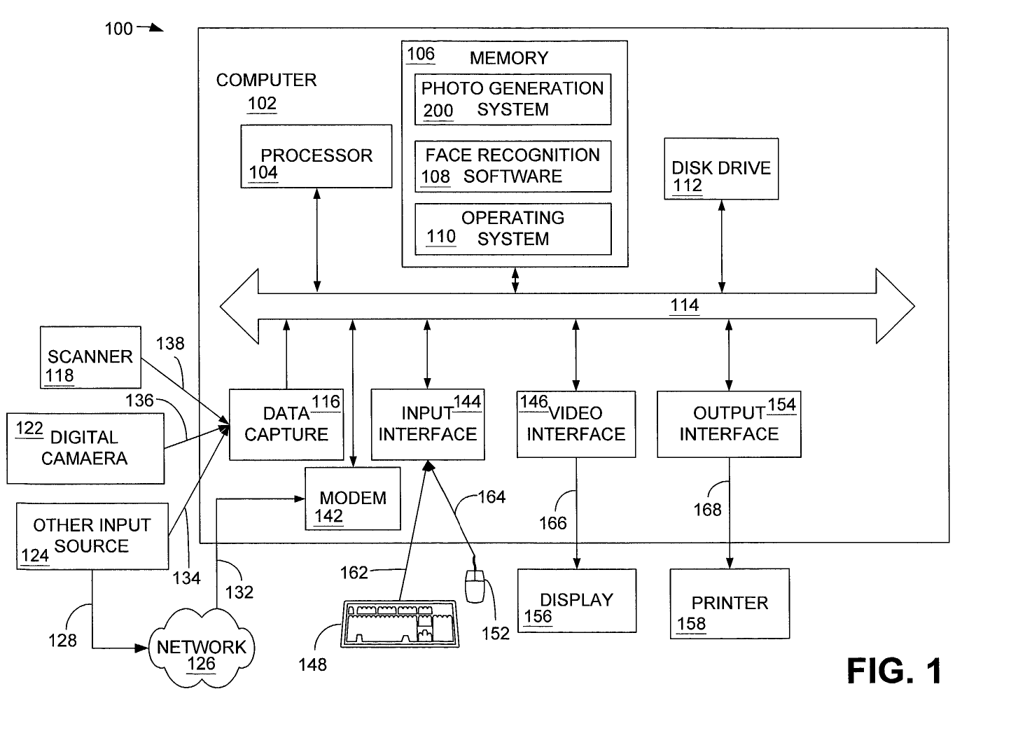

The photograph generation system of the invention can be implemented in software (e.g., firmware), hardware, or a combination thereof. In the currently contemplated best mode, the photograph generation system is implemented in software and executed by a special or general purpose computer, such as a personal computer (PC; IBM-compatible, Apple-compatible, or otherwise), workstation, minicomputer, or mainframe computer. An example of a general purpose computer that can implement the photograph generation system of the invention is shown in FIG. 1.

FIG. 1 is a block diagram illustrating a computer and scanner system 100 that includes the photograph generation system 200 of the invention. The system 100 includes a general purpose computer 102 that can implement the photograph generation system 200. Generally, in terms of hardware architecture, as shown in FIG. 1, the computer 102 includes a processor 104, memory 106, a disk drive 112, an input interface 144, a video interface 146 and an output interface 154 that are connected together and can communicate with each other via a local interface 114. The local interface 114 can be, for example but not limited to, one or more buses or other wired or wireless connections, as is known in the art. The local interface 114 may have additional elements, which are omitted for simplicity, such as buffers (caches), drivers, and controllers, to enable communications. Further, the local interface 114 includes address, control, and data connections to enable appropriate communications among the aforementioned components.

The processor 104 is a hardware device for executing software that can be stored in memory 106. The processor 104 can be any custom made or commercially available processor, a central processing unit (CPU) or an auxiliary processor among several processors associated with the computer 102, and a microchip based microprocessor or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 106 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 106 may incorporate electronic, magnetic, optical, and/or other types of storage media. Note that the memory 106 can have a distributed architecture, where various components are situated remote from one another, but can be accessed by the processor 104.

The input interface 144 can receive commands from, for example, keyboard 148 via connection 162 and from mouse 152 via connection 164 and transfer those commands over the local interface 114 to the processor 104 and the memory 106. The video interface 146 supplies a video output signal via connection 166 to the display 156. The display 156 can be a conventional CRT based display device, or can be any other display device, such as a liquid crystal display (LCD) or other type of display.

The output interface 154 sends printer commands via connection 168 to the printer 158. The modulator/demodulator (modem) 142 can be any communication device capable of connecting the computer 102 to an external network 126. The network 126 may be a wide area network (WAN) or local area network (LAN).

Information in the form of photographic images can be supplied to the computer 102 via the data capture element 116. The data capture element 116 receives electronic images from a variety of different image sources. For example, the data capture element 116 receives electronic images from the scanner 118 via connection 138, from a digital camera 122 via connection 136 or from another input source 124 via connection 134. Alternatively, the modem 142 can be used to access network 126, through which the other input source 124 communicates via connection 128 to deliver electronic image files to the computer 102 and to the photograph generation system 200. Yet another manner in which an electronic image may be provided to the photograph generation system 200 is where an electronic image is stored in the disk drive 112. The disk drive 112 can be either internal to the computer 102 as shown, or can be external to the computer 102.

Once an electronic image is made available to the photograph generation system 200, the photograph generation system 200 can capture portions of the image and print those selected portions of the image in a predetermined size and format. The selected portions of the image can be defined by the user of the photograph generation system 200, or can be automatically identified by, for example, face recognition software 108. Face recognition software 108 automatically identifies faces in an image and can be used to identify the selected print subject.

The software in memory 106 may include one or more separate programs, each of which comprises an ordered listing of executable instructions for implementing logical functions. In the example of FIG. 1, the software in the memory 106 includes the photograph generation system 200, face recognition software 108 and a suitable operating system (O/S) 110. A nonexhaustive list of examples of suitable commercially available operating systems 110 is as follows: a Windows operating system from Microsoft Corporation, U.S.A., a Netware operating system available from Novell, Inc., U.S.A., or a UNIX operating system, which is available for purchase from many vendors, such as Hewlett-Packard Company, U.S.A., Sun Microsystems, Inc., and AT&T Corporation, U.S.A. The operating system 110 essentially controls the execution of other computer programs, such as the photograph generation system 200 and the face recognition software 108, and provides scheduling, input-output control, file and data management, memory management, and communication control and related services. The processor 104 and operating system 110 define a computer platform, for which application programs, such as the photograph generation system 200, in higher level programming languages are written.

If the computer 102 is a PC, the software in the memory 106 further includes a basic input output system (BIOS) (omitted for simplicity). The BIOS is a set of essential software routines that test hardware at startup, start the O/S 110, and support the transfer of data among the hardware devices. The BIOS is stored in ROM as that it can be executed when the computer 102 is activated.

When the computer 102 is in operation, the processor 104 is configured to execute software stored within the memory 106, to communicate data to and from the memory 104, and to generally control operations of the computer 102 pursuant to the software. The photograph generation program 200 and the O/S 110, in whole or in part, but typically the latter, are read by the processor 104, perhaps buffered within the processor 104, and then executed.

When the photograph generation system 200 is implemented in software, as is shown in FIG. 1, it should be noted that the photograph generation system 200 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The photograph generation system 200 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the photograph generation system 200 is implemented in hardware, the photograph generation system 200 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

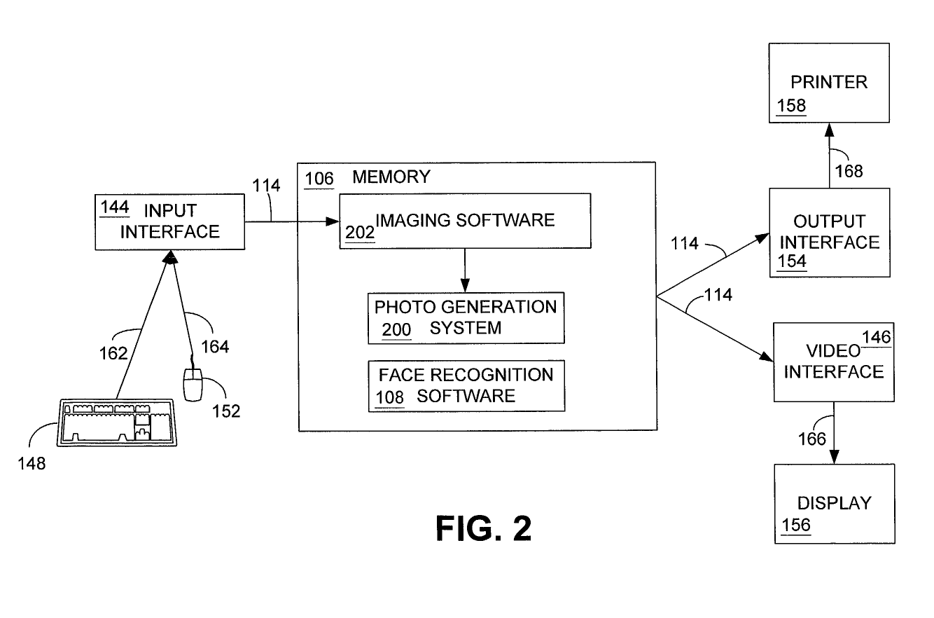

FIG. 2 is a schematic view illustrating the input interface 144 and photo generation system 200 of FIG. 1. The photograph generation system 200 enables an electronic representation of an image to be processed by a computer and delivered to a printer for printing in a chosen format. When the image is displayed to a user of a computer system, the invention enables the user to select portions of the image for printing and will print the selected portions in a user defined size and format. The user may have a selection from which to choose the size and format in which the image will be printed. For example, the invention is useful for formatting an electronic representation of an image into “passport” size for printing. The “passport” size image is photographically printed and immediately available for submission to the passport office. Other predefined sizes and formats are also possible. Furthermore, it is possible for the user to specify the size and format of the printed image.

The input interface 144 receives input commands from the keyboard 148 via connection 162 and receives input commands from the mouse 152 via connection 164. The input commands are sent through the input interface 144 via local interface 114 and into the imaging software 202 contained within memory 106. The imaging software 202 includes software that is known to those having ordinary skill in the art and enables the computer 102 of FIG. 1 to generally process electronic image files. The memory 106 also includes photograph generation system 200 of the invention. The photograph generation system 200 receives inputs from the imaging software 202 and provides a user with various selections as to the manner, size, shape and format in which the electronic image supplied to data capture element 116 (FIG. 1) can be printed.

During operation, the photograph generation system 200 allows a user to view the image file via video interface 146 and display 156 while selecting the portion of the image file to print. The photograph generation system 200 also allows the user to select the format in which the selected portion of the image file will be printed. The photograph generation system 200 also communicates via local interface 114 with the output interface 154 so that the appropriate portion of the input image can be printed as a photograph on printer 158.

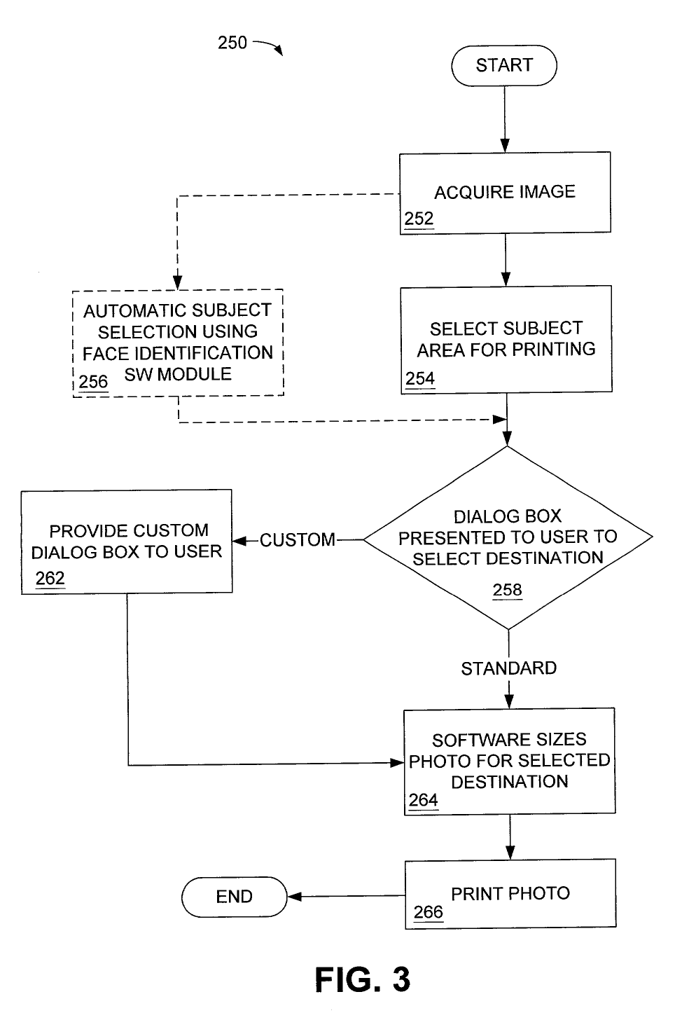

FIG. 3 is a flow diagram 250 illustrating the operation of the photograph generation system 200. In block 252 an electronic image is acquired by the computer 102 (FIG. 1) via the data capture element 116 (FIG. 1). The data capture element 116 can receive an electronic image file from, for example, the scanner 118, the digital camera 122, which may be a digital still camera or a digital movie camera, or from another input source 124. Alternatively, the electronic image file may be stored on disk drive 112 in computer 102. The image may be supplied to the disk drive 112 via, for example, a removable memory element.

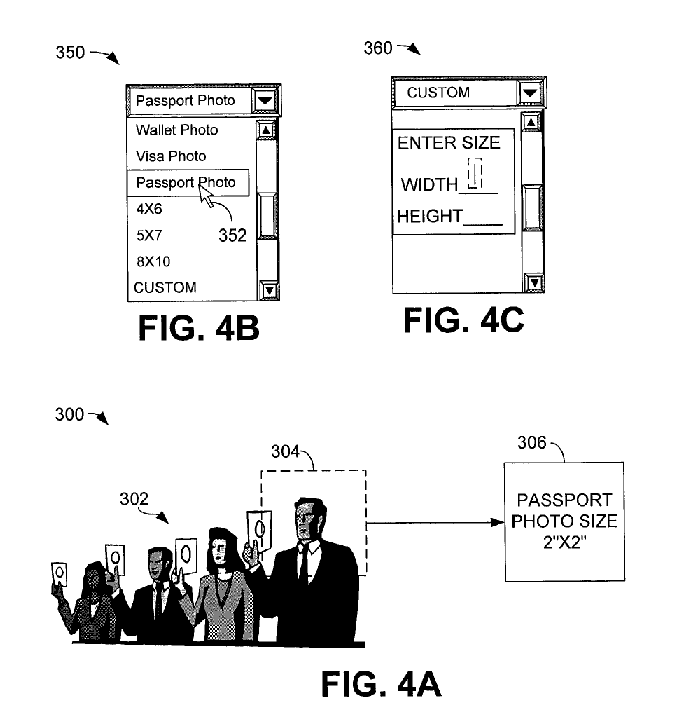

In block 254, the acquired image is viewed on display 156 by a user (FIG. 1) so that the user can select the subject area of the image that is to be printed. For example, FIG. 4A shows an example of an image 302 that can be viewed by the user of the system on the display 156. The user selects the subject area for printing by, for example, using the mouse 152 to click on a particular portion of the image 302, or by using the mouse 152 to click and drag bounding box 304 around a portion of the image 302. In the example shown in FIG. 4A, the bounding box 304 surrounds an image of a face to be printed. In this manner, the user of the photograph generation system 200 selects the image to be printed on printer 158.

Referring back to FIG. 3, in block 256 another manner of selecting the subject to print is described. In block 256, the subject for printing is automatically selected using, for example, the face recognition software 108 of FIG. 2. The face recognition software 108 automatically identifies faces in an image and can be used to identify the selected print subject. The face recognition software 108 can be used in conjunction with a bounding box 304 or other object selection techniques. For example, the face recognition software 108 can be used to locate a face within a bounding box 304. Alternatively, other techniques can be used to select the subject area for printing.

After the subject area for printing is selected a dialogue box is presented to the user in block 258. FIG. 4B illustrates one example of a dialog box 350 that presents to the user a number of possible print destinations, or formats, in which the image can be printed. Alternative sizes and formats in which the image will be printed are presented to the user. For example, the user is presented with choices including passport size, wallet size, visa size, 4″×6″, 5″×7″, 8″×10″, or a custom size. During step 258, the dialogue box 350 will be presented to the user via the display 156. Using the mouse 152, the user moves the pointer 352 to select, for example, a passport photo size printed image. By selecting the passport photo size printed image, the user communicates to the photograph generation system 200 that the user desires the selected image (the image that was selected as described above using, for example, the bounding box 304 of FIG. 4A) to be printed in a 2″×2″ passport photo size format. In this manner, the photograph generation system 200 allows a user to choose any arbitrarily sized image on the display and have that image printed in a passport photograph size. As illustrated using the dialog box 350 in FIG. 4B, other standard size images can be printed.

If, in block 258 the user selects the option “custom” from the dialogue box 350 of FIG. 4B, then, in block 262, a custom dialogue box 360, an example of which is illustrated in FIG. 4C, is presented to the user. In the custom dialogue box 360, the user can choose a “non-standard” print size by entering the desired print size in the appropriate locations. The photograph generation system 200 then prints the selected image in a size corresponding to the user input.

In block 264, the photograph generation system 200 sizes, or scales, the photo for the selected print format. For example, the photograph generation system 200 can scale the photo for printing using a standard bicubic scaling algorithm as known to those having ordinary skill in the art. In block 266 the passport photo size image is printed on printer 158 (FIG. 2).

It will be apparent to those skilled in the art that many modifications and variations may be made to the preferred embodiments of the present invention, as set forth above, without departing substantially from the principles of the present invention. For example, the photo generation system can be used to print various image sizes regardless of the size of the input image. All such modifications and variations are intended to be included herein within the scope of the present invention, as defined in the claims that follow.

What is claimed is:

1. A system for selecting a particular size image to print, comprising:
a computer adapted to receive an electronic image file; and
a photograph generation software component in communication with the computer, the photograph generation software component adapted to analyze the electronic image file and present to a user a plurality of image formats from which the user selects a desired format.

2. The system of claim 1, further comprising a printer adapted to print the electronic image file in the selected image format.

3. The system of claim 2, wherein one of the plurality of image formats is a passport size photograph.

4. The system of claim 1, wherein the image format is chosen from the group consisting of wallet size, visa size, 4″×6″, 5″×7″, and 8″×10″.

5. The system of claim 1, wherein the photograph generation software component automatically selects an image format.

6. The system of claim 1, wherein the photograph generation software component allows a user to customize the image format.

7. The system of claim 1, wherein a user of the photograph generation software component selects a portion of the electronic image file to be printed in the desired format.

8. The system of claim 1, further comprising a face recognition software component configured to select a portion of the electronic image file to be printed in the desired format.

9. The system of claim 1, further comprising a scanner including the photograph generation software component.

10. A method for selecting a particular size image to print, the method comprising the steps of:
providing an electronic image file to a computer;
selecting the electronic image file; and
presenting to a user a plurality of image formats from which the user selects a desired format with which to print the selected electronic image file.

11. The method of claim 10, further comprising the step of printing the selected electronic image file in the selected image format.

12. The method of claim 11, wherein one of the plurality of image formats is a passport size photograph.

13. The method of claim 10, wherein the image format is chosen from the group consisting of wallet size, visa size, 4″×6″, 5″×7″, and 8″×10″.

14. The method of claim 10, further comprising the step of automatically selecting the image format.

15. The method of claim 10, further comprising the step of customizing the selected image format.

16. The method of claim 10, further comprising the step of selecting a portion of the electronic image file to be printed in the desired format.

17. The method of claim 10, further comprising the step of using a face recognition software component to select a portion of the electronic image file to be printed in the desired format.

18. The method of claim 10, wherein a scanner provides the electronic image file to the computer.

19. A method for printing a passport format image, the method comprising the steps of:
providing an electronic image file to a computer;
selecting the electronic image file;
scaling the selected image file based on a predetermined print format, the predetermined print format corresponding to a passport photograph format; and
printing the selected image file in the passport photograph format.

20. The method of claim 19, further comprising the step of automatically selecting the predetermined print format.

21. The method of claim 19, further comprising the step of selecting a portion of the electronic image file to be printed in the predetermined print format.

22. The method of claim 19, further comprising the step of using a face recognition software component to select a portion of the electronic image file to be printed in the predetermined print format.

23. The method of claim 19, wherein the electronic image file corresponds to a photograph.

24. The method of claim 19, wherein a scanner provides the electronic image file to the computer.
